(19) United States
(12) Patent Application Publication
(10) Pub. No.: US 2008/0022567 A1
(43) Pub. Date: Jan. 31, 2008

(54) Themed Greeting Card Frame and Holder for a Theme-Related Item

(76) Inventors: Ralph Marotta, Johnstown, NY (US); Lawrence Richard McMullen, Johnstown, NY (US)

Correspondence Address: DELAIN & LIEBERT, PLLC, 400 CLIFTON CORPORATE PARKWAY, SUITE 470, CLIFTON PARK, NY, 12065, US

(21) Appl. No.: 11/460,248

(22) Filed: Jul. 27, 2006

(51) Int. Cl. G09F 1/00

(52) U.S. Cl. 40/124.06

(57) ABSTRACT

A themed greeting card is disclosed, comprising a body composed of a member of the group consisting of paper products, paper, card stock, cardboard, wood, stone, plastic, porcelain, vinyl and metal, said body comprising a front, a back, a top, a bottom, a right side, and a left side; a holder of sufficient size to hold a theme-related item of trading-card size affixed to said greeting card, said holder being a planar member with a top, a bottom, a left side, a right side, and a central portion, said holder being affixed to said body inside or body outside such that said theme-related item can be inserted between said holder and said body, and said holder being composed of a transparent material; and a display mechanism for said holder such that said themed greeting card forms a frame for said holder. The themed greeting card comes with an optional

[symbol]

### BACKGROUND OF THE INVENTION

1. Field of the Invention

The fields of the invention are gifts, specifically holders for a theme-related item, and themed greeting cards, specifically greeting cards that can also be used to hold a small item.

2. Description of Related Art

U.S. Pat. No. 4,203,239 teaches a picture holding device injection molded of clear plastic is provided wherein a plurality of profile shapes with opposing channels are interconnected so as to allow a number of transparent picture holding sleeves to be inserted in the channels. The channels are separated horizontally and vertically so as to provide an essentially unobstructed view of each picture by merely changing the viewing angle.

U.S. Pat. No. 4,309,835 teaches a foldable frame having a four-sided base with a wall portion extending from each side of the base. An extension is detachably secured to the end of each wall portion along the edge of the wall portion remote from the attachment of the wall portion to the base. The extension and wall portion are substantially equal in dimension to the base such that each extension and wall portion may be folded to substantially overlie the base with the extensions providing area for promotional information thereon.

U.S. Pat. No. 5,082,122 teaches a display unit is disclosed for displaying a plurality of display items contained in holders. Each display unit is a thin, rectangular planar member. Locators, which include associated stanchions, define locations on each display unit for receiving display item holders. A cap engages each stanchion to secure the display item holders. Studs protruding along the lower edge of a unit fit into slots located along the top and sides of other units, and form a multi-unit display center. The preferred configuration is an open-faced, open-top display center having a base formed of two display units connected together, and sides and backs formed by three display units connected to and upstanding from the base. Display item holders and their contents are visible within the four interior surfaces of the display center. Means for adjusting the viewing angle of the upstanding sides of the display center is also disclosed.

U.S. Pat. No. 5,174,442 teaches a packaging device for an audio cassette comprising a sleeve having opposed front and rear walls, opposed side walls and end openings for permitting the introduction of a cassette within a sleeve. A flap extends from the sleeve and is easily detachable from the sleeve to define a card, which has printed material thereon related to the audio material recorded on said tape.

U.S. Pat. No. 5,671,555 teaches a sports greeting card with a microchip voice synthesizer installed. The inventor specifically claims that his card is for “generating a voice interactive conversation and physical interaction between the user and the voice sportscard”.

U.S. Pat. No. 5,848,686 teaches an improved collating structure capable of receiving, storing, displaying, withdrawing and reinserting a multiplicity of at least two different functionally-related and/or traditionally-associated items is disclosed. An insert which is removably disposed with a main body portion defines a first compartment within the collating structure. A tray including a recessed area or, alternatively, a pocket, defines a second compartment within the collating structure. The tray (or pocket) is capable of sliding between a first position hidden underneath and within the insert and a second position extending outwardly and above the insert to provide visual and actual access to the second compartment. The separate compartments are capable of containing functionally-related and/or traditionally-associated items, such as greeting cards and envelopes or trading cards and card mounts, in a manner which provides quick and easy access to such items and limits the overall size of the collating structure.

U.S. Pat. No. 5,979,097 teaches a display device, kit, system and method which utilizes an item holder in combination with an angled frame to provide a protective, aesthetically pleasing, versatile display of one or more items such as trading cards, sports cards, racing cards, photographs, greeting cards, prints, and the like. In accordance with an exemplary embodiment, the display device includes a substantially rectangular, transparent, trading card holder attached to the back surface of an angled frame, a primary mat adapted to be placed adjacent one surface of the frame and to serve as a mat in association with the front of the trading card being viewed through the frame, and a secondary mat adapted to be placed adjacent one surface of the item holder and to serve as a mat in association with the back side of the trading card being viewed through the item holder. In accordance with another example, the display device further includes a sound emitting device attached to the frame. In accordance with still another example, the display device further includes a sound emitting and recording device attached to the frame. The first and second mats or borders and the sound emitting or sound emitting and recording devices add to the enjoyment of and enhance the viewing experience of viewing the item or items retained in the item holder by having colors, graphics, text, pictures, sounds, speech, and the like which compliment, personalize, or relate in some way to the item being displayed.

U.S. Pat. No. 6,061,938 teaches a changeable image display device that has a front panel and a back panel forming an envelope open at one end. The front panel has first and second spaced windows and the back panel has a first image thereon in alignment with the first window of the front panel. A stationary transparency is fixed between the front and back panels and has second and third visual images thereon. A slidable V-shaped insert in the device moves between recessed and retracted positions and has first and second legs straddling the stationary transparency. A third window in the first leg of the V-shaped insert exposes the second visual image in the recessed position and exposes the third visual image in the retracted position. The second leg of the V-shaped insert covers the first visual image in the recessed position and exposes the first visual image in combination with the second visual image in the retracted position.

U.S. Pat. No. 6,643,962 teaches a card with pop-out object and display system is disclosed. The display card generally comprises a base having a non-display surface and an opposing display surface and comprising a platform portion disposed between at least two support portions for supporting the platform portion when the display card is in a display configuration, and at least two flaps securable to the non-display surface of the base when the display card is in a generally flat, storage configuration and securable to the display surface when the card is in the display configuration, wherein the non-display surface is generally hidden from view when the display card is in the display configuration. The display card typically further includes an object and an object housing attached to the non-display surface of the base. The object housing defines an opening for removably storing the object therein. The base serves as a backing to the object when the object is stored in the object housing. In addition, the platform portion secures and displays the object thereon such that the opening defined in the object housing is generally hidden from view when the display card is in the display configuration.

US Patent Application No. 20030116467 teaches a device for storing and displaying collectable items while simultaneously providing information concerning the collectable items therein is disclosed. The device includes a container having peripheral walls supported by a bottom member and which define an open enclosure having an open top. A removable lid is provided and has an outer surface and an inner surface, the lid being sized and shaped to selectively cover the open top to enclose the container. At least one divider element is disposed in the container on the bottom member to define interior compartments open to the open top. A plurality of collectable items are each removably positioned in one compartment. Finally, a plurality of identification members are disposed on the lid inner surface and are arranged to correspond with the compartmentalized collectable items, each identification member having educational information concerning the particular collectable item disposed in the corresponding compartment.

US Patent Application No. 20060010734 teaches greeting or announcement card includes integrated picture mailer and frame. An illustrative embodiment of the card is made by die cutting thick paper stock. The card includes front and back portions disposed side-by-side, and a middle portion disposed under the back portion. Adhesive strips cover the inside of the back portion or of the middle portion. When the card is assembled, it is folded along a line to bring into contact the inside surfaces of the middle and back portions, forming a holding pocket open on one side. A picture can be inserted into the pocket and viewed through an aperture in the middle portion. After insertion, the front portion is folded towards the pocket, and the card is mailed. The card's recipient tears off the front portion, and pulls on a precut tab in the back portion, forming a picture frame with an easel-like stand.

US Patent Application No. 20060086015 teaches a pop-up calendar display having one or more pop-up sports figures disposed therein. The pop-up calendar display card includes a cardboard blank member having a fold line for forming a base member and a vertical display member. The base member is for resting on a flat surface, and the vertical display member is for being vertically positioned on the flat surface relative to the fold line. The vertical display member and the base member each includes one or more pop-up display sections being partially cut out from the vertical display member and the base member. The vertical display member is movable between a first position, and a second display position. The pop-up display sections are movable between a first position, and a second display position. The base member is for supporting the pop-up calendar display, and having indicia thereon in the form of calendar information. The vertical display member is used for depicting a sporting event; and the pop-up display sections are in the form of one or more sports figures.

There is an unmet need in the marketplace for a themed greeting card that can be displayed and showcased as a collector's item with a theme-related item such as a trading card or event tickets or a similarly sized item that continues the theme of the greeting card.

### BRIEF SUMMARY OF THE INVENTION

The present invention meets the marketplace need for a themed greeting card that can be displayed and showcased as a collector's item with a theme-related item such as a trading card or event tickets or a similar-sized item that continues the theme of the greeting card. The invention comprises a themed greeting card frame that contains a pocket or holder for a removable, replaceable theme-related item such as a sports card, event tickets, or a small photograph. The greeting card is

### BRIEF DESCRIPTION OF THE DRAWINGS

FIG. 1 shows a themed greeting card 100 is shown in four orientations in a closed position.

FIG. 2 shows a themed greeting card opened to display the inside of the greeting card The themed greeting card has affixed to it a holder.

FIG. 3 shows a cross-section of the holder in relation to the themed greeting card.

FIG. 4 shows a themed greeting card opened at its fold to form a framing display for a trading card or other similarly sized item that continues the theme of the greeting card.

FIG. 5 shows a multi-paged themed greeting card with a holder affixed thereto.

FIG. 6 shows a themed greeting card in a configuration that is not folded at all, similar to a postcard, with a holder for a themed item being affixed to the themed greeting card.

FIG. 7 shows a themed greeting card is shown with text.

FIG. 8 shows a themed greeting card with two folds, creating three panels, with a holder affixed to the card.

FIG. 9 shows a tri-paneled themed greeting card opened as a stand to reveal a holder.

FIG. 10 shows a themed greeting card with a holder for a theme-related trading-card sized item and a mounting base for showcasing the greeting card and theme-related item.

### DETAILED DESCRIPTION OF THE INVENTION

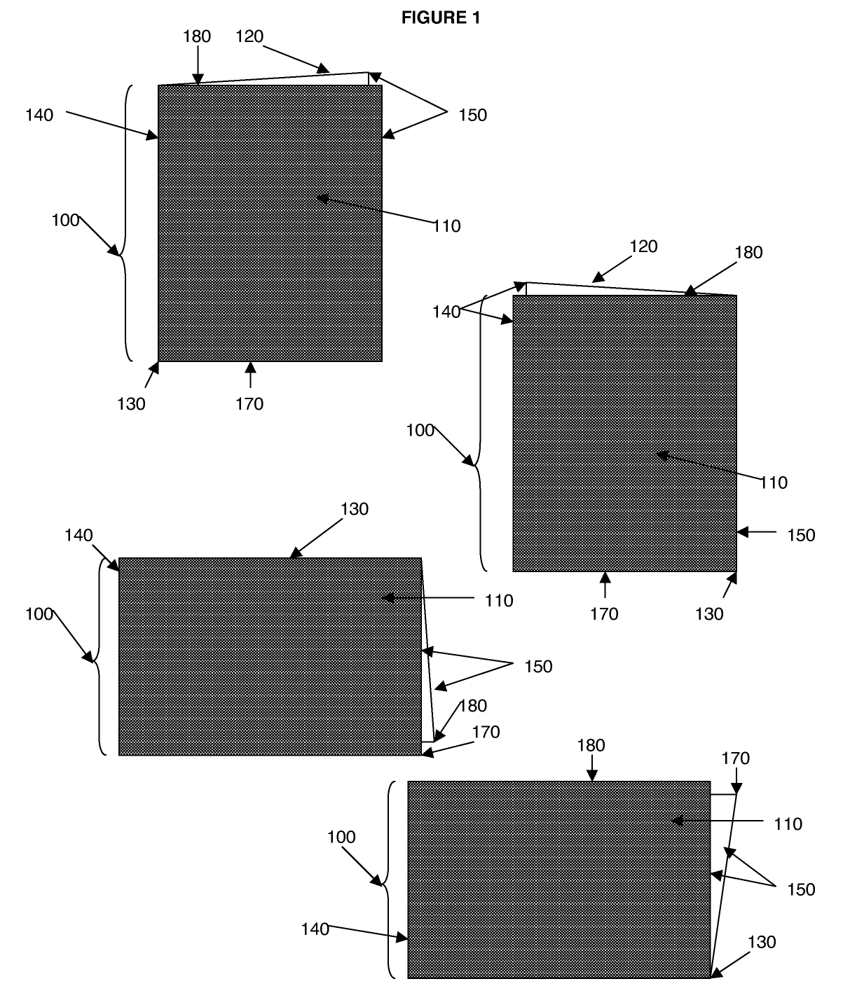

Referring now to FIG. 1, a themed greeting card 100 is shown in four orientations in a closed position. The card 100 has an exterior 110 and an interior 120. In one orientation, the card 100 is folded 130 down the left side 140. In another orientation as shown, the card 100 is folded 130 down the right side 150. In another orientation, the card 100 is folded 130 along a horizontal line 160 and is oriented such that the card opens from bottom 170 to top 180. In another orientation, the card 100 is folded 130 along a horizontal line 160 and is oriented such that the card 100 opens from top 180 to bottom 170. The card 100 may also be of an unfolded configuration, not shown, such as a postcard. The card 100 may be made of any substance that can be used to make a greeting card, including but not limited to paper products such as paper, card stock or cardboard, wood, stone, plastic, porcelain, vinyl, metal, or any material that can be used as a base for a holder affixed thereto with an adhesive such as tape or glue.

Note that FIG. 1 shows the themed greeting card in various orientations with one fold. However, the various single-folded orientations of the themed greeting card are not limited only to FIG. 1, but carry throughout the invention. The various orientations shown in FIG. 1 are omitted only for convenience from successive drawings, and all drawings showing a single fold configuration should be construed to include all of the orientations shown in FIG. 1.

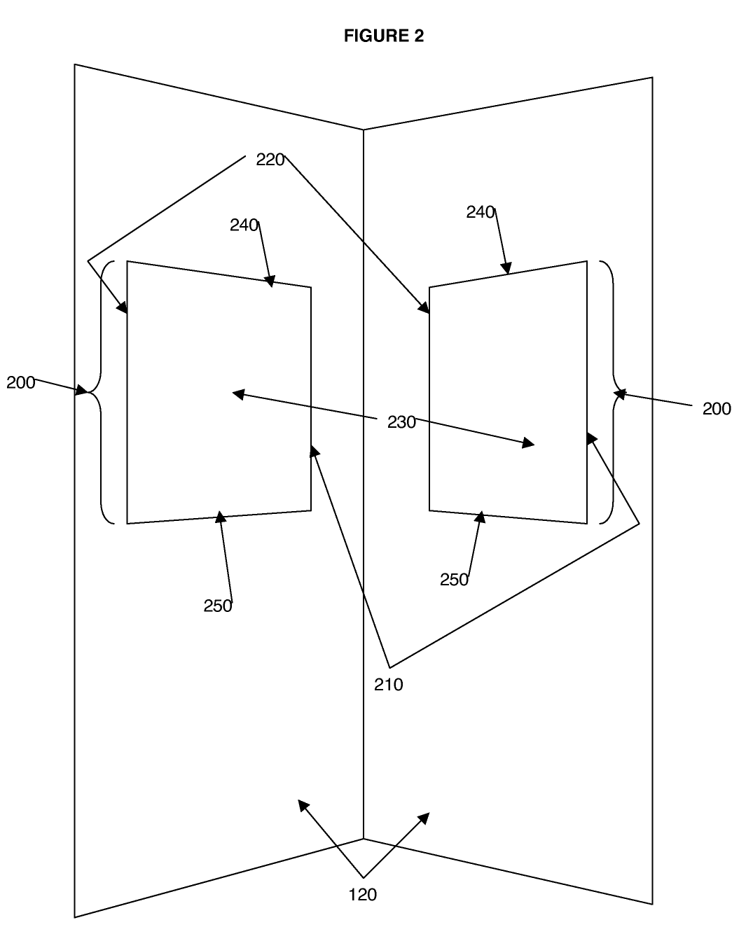

Referring now to FIG. 2, a themed greeting card 100 is shown opened to display the inside 120 of the greeting card 100. The themed greeting card 100 has affixed to it a holder 200 on the left-hand side 140 and the right-hand side 150 inside 120 of the themed greeting card 100 in this embodiment. In another embodiment, there may be only one holder 200 attached to either the left-hand side 140 or the right-hand side 150 of the inside 120 of the themed greeting card 100.

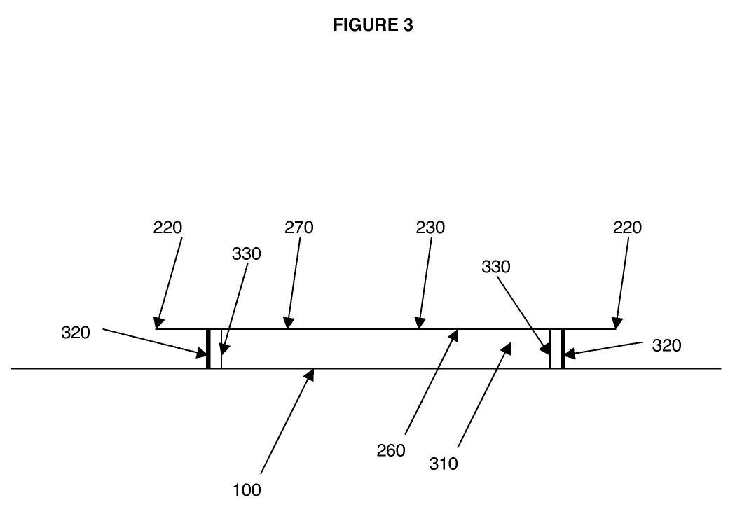

A holder 200 for a trading-card-sized object is an integral part of the invention. The holder 200 is a planar member that has a right side 210, a left side 220, a center 230, a top side 240, a bottom 250, an inside 260 located adjacent to the body of the themed greeting card (inside 260 shown in FIG. 3) and an outside 270 located opposite the inside 260 (outside 270 shown in FIG. 3). The holder is made of a transparent material that is usually plastic, but the material may be any transparent material capable of holding a trading-card sized object in place, including but not limited to any transparent silicon (glass) or petroleum (carbon-based) product.

Note that the holder 200 may be located either on the exterior 110 or the interior 120 of the themed greeting card 100.

Referring now to FIG. 3, a cross-section of the holder 200 in relation to the themed greeting card 100 is shown. This orientation shows the holder 200 is separated by a space 310 from the card 100 and is held in place with an adhesive means 320, said adhesive means including using an adhesive material such as glue to adhere the holder 200 to the card 100, using heat sealing to adhere the holder 200 to the card 100, or stapling the holder 200 to the card 100.

The outer edge 220 of the holder 200 may or may not be adhered to the card 100; there may be a margin 330 between the edge 220 of the holder and the adhesive means 320 to the card 100. The width of the margin 330 is inconsequential to the invention disclosed herein.

The space 310 must be of sufficient dimension to receive and hold a trading-card sized object. The space 310 is maintained either with the adhesive means 320 or with a support 330, or with a combination as shown in FIG. 3. The support 330 may be made of any firm material capable of holding the card 100 and holder 200 separate. In an embodiment where no support 330 is used (such embodiment is not shown in the drawings), the adhesive means 320 must be of sufficient thickness to keep the holder 200 and the card 100 separated sufficiently to allow the insertion of a trading-card sized object. In any case, the adhesive means 320 must be of sufficient adhesive strength to keep the holder 200 firmly affixed to the card 100.

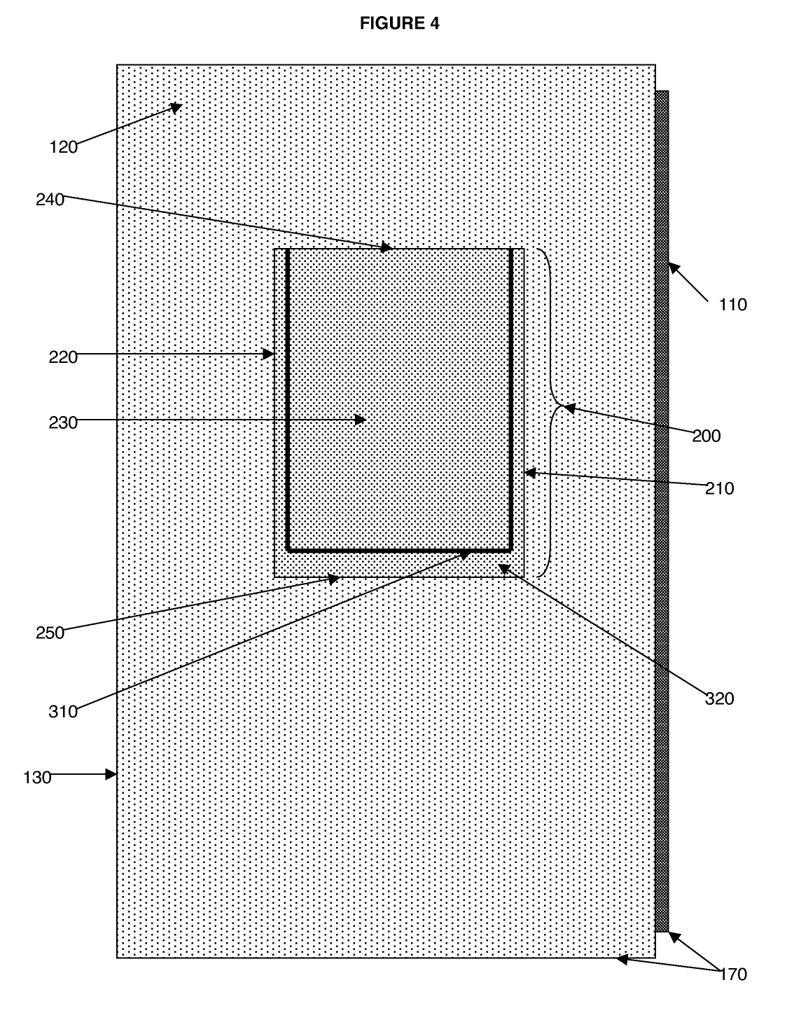

Referring now to FIG. 4, a themed greeting card 100 is opened at its fold 130 to form a framing display for a trading card or other similarly sized item that continues the theme of the greeting card 100. The themed greeting card 100 forms a frame or stand for a themed item that may be placed within the holder 200. This frame is made by folding the outside 110 of the themed greeting card back such that the inside 120 of the themed greeting card 100 is fully exposed, and standing the folded 130 card 100 on its bottom 170 edge.

Alternatively, the greeting card 100 or the contents of the holder 200 may be displayed in a commercially available frame.

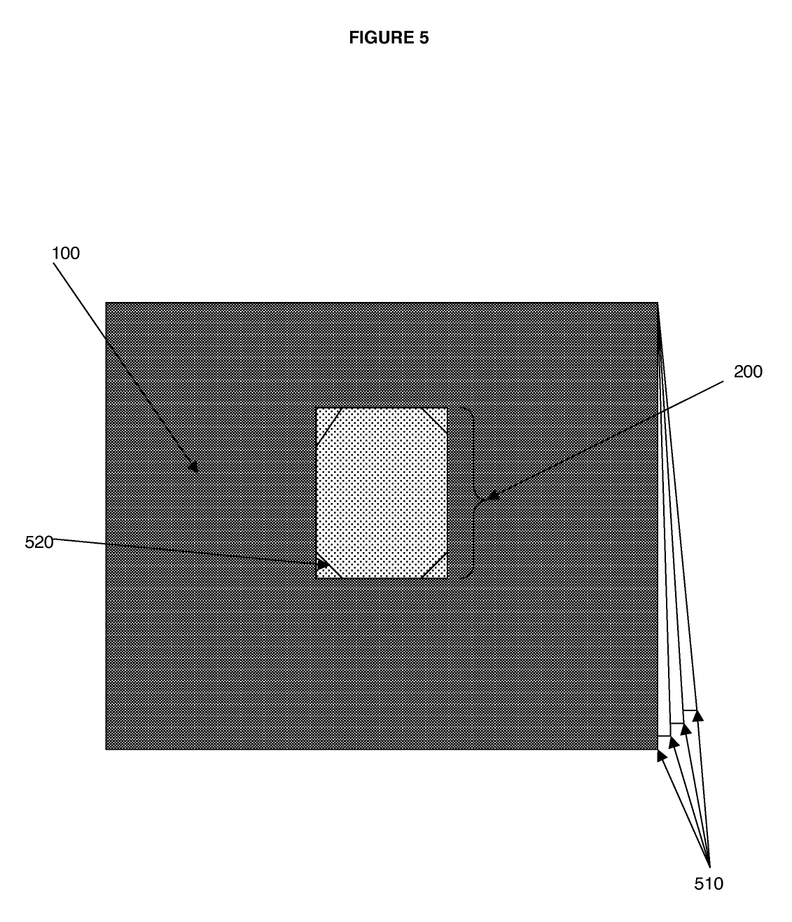

Referring now to FIG. 5, a multi-paged 510 themed greeting card 100 is balanced to form a display for a trading card or other item that continues the theme of the greeting card 100, said trading card or other similarly sized themed item being located in a holder 200 affixed to said themed greeting card 100. Note that a holder 200 is located on the exterior 110 of the greeting card 100.

A themed greeting card 100 in this configuration may be displayed in a frame, stood on end, or used as a book-type display.

An alternate embodiment of the holder 200 is shown wherein the holder 200 is two or four diagonally opposite slits 520 in the card 100 such that a trading card or similarly sized item would be held by the corners of the trading card being inserted into each slit 520.

In a variation on the embodiments shown in FIG. 2 and FIG. 5, one or more holders 200 may be affixed to any one or more of the interior 120 pages 510 of the themed greeting card 100.

Note that one embodiment shows the holder 200 mounted vertically on the themed greeting card 100.

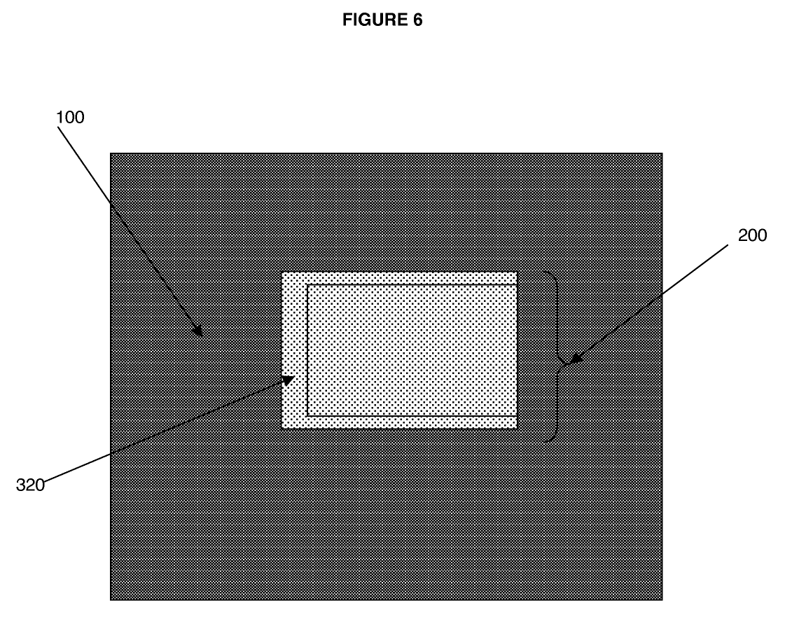

Referring now to FIG. 6, a themed greeting card 100 is shown in a configuration that is not folded at all, similar to a postcard, with a holder 200 for a themed item being affixed to the themed greeting card 100 with an adhesive means 320. A card 100 in this configuration may be mounted for displaying in an external device such as a commercially available frame that is outside the scope of this disclosure.

Note that one embodiment shows the holder 200 mounted horizontally on the themed greeting card 100.

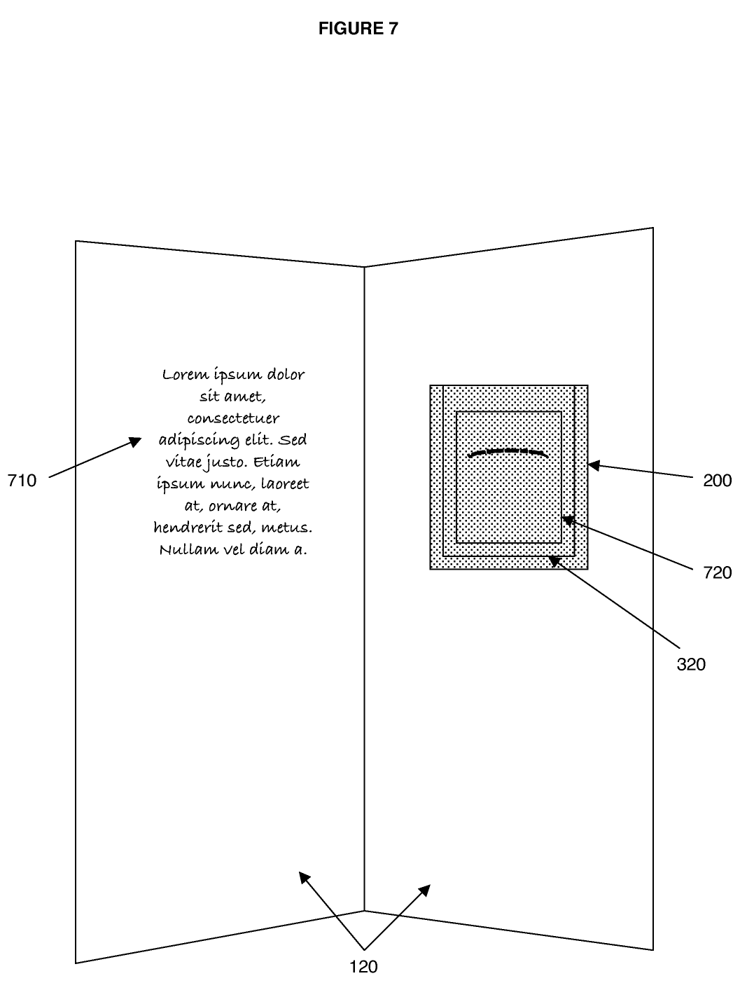

Referring now to FIG. 7, a themed greeting card 100 is shown with text 710. The text 710 may be any text appropriate to the theme of the card 100. The text 710 may be in any written language. The text 710 may be in any typeface. The text 710 may be in any point size that fits on the greeting card 100. The text may be located on the outside 110 or inside 120 of the card 100.

A themed trading card 720 is shown in position within the holder 200. The themed trading card 720 is held within the holder 200, which is affixed to the card 100 by an adhesive means 320.

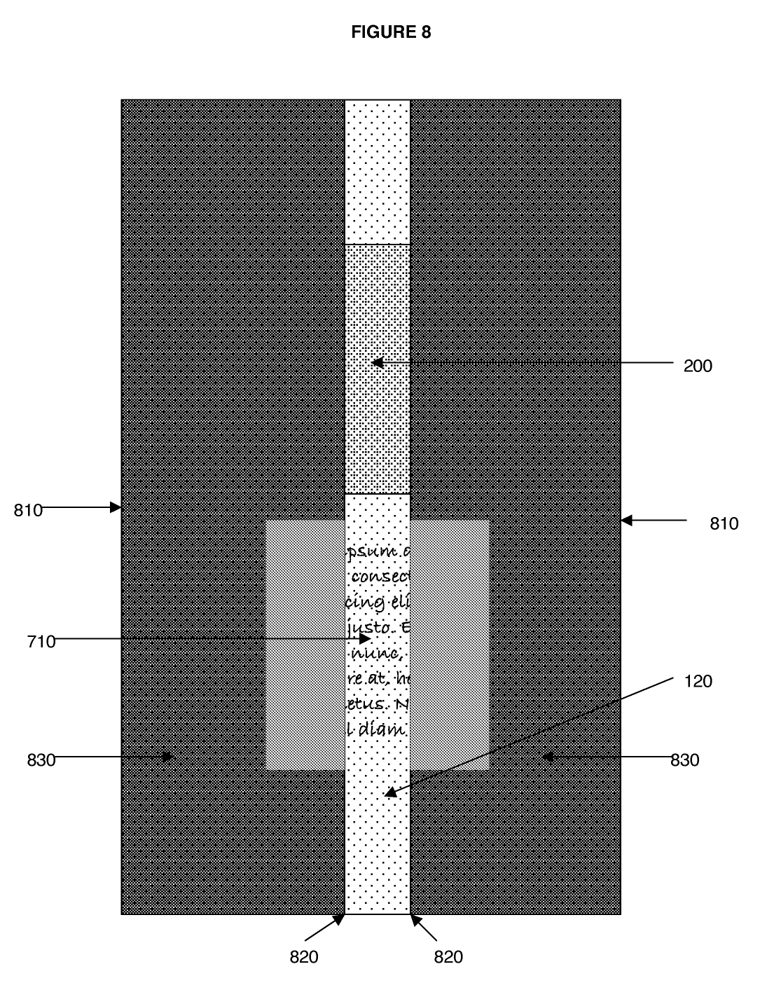

Referring now to FIG. 8, another alternate embodiment of the invention is shown. A card 100 has two folds 810 substantially equidistant from the edges 820 of the card 100. This creates three panels 830: two on the sides of the card 100 and one in the center.

The card 100 has affixed to it a holder 200. The holder 200 is shown as being affixed to the inside 120 of the card on the center panel 830; however, this is merely an example of placement of the holder 200. The holder 200 may be affixed to any panel 830 of the card 100, and may be affixed to the outside 110 of the card 100 or the inside 120.

In an alternate embodiment, not shown, a holder is attached to more than one panel 830. This embodiment has at least two holders 200 on the card 100, which provides more than one space for a themed trading-card sized object to be inserted. Thus, the card 100 may be used as a stand or frame for at least two themed trading-card sized objects.

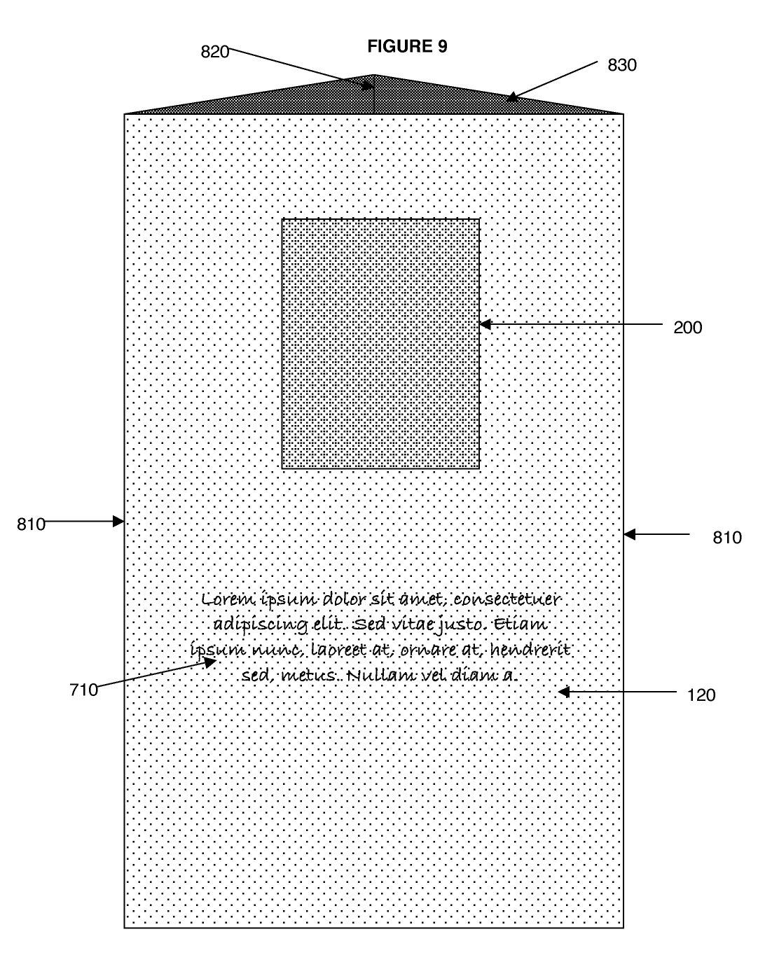

Referring now to FIG. 9, a tri-paneled 830 themed greeting card 100 is opened as a stand to reveal a holder 200 displayed. The edges 820 of the card 100 may meet (as shown), or they may be separated (not shown). The edges 820 may have a device such as a slot and tab (not shown) to hold them in a position where they touch.

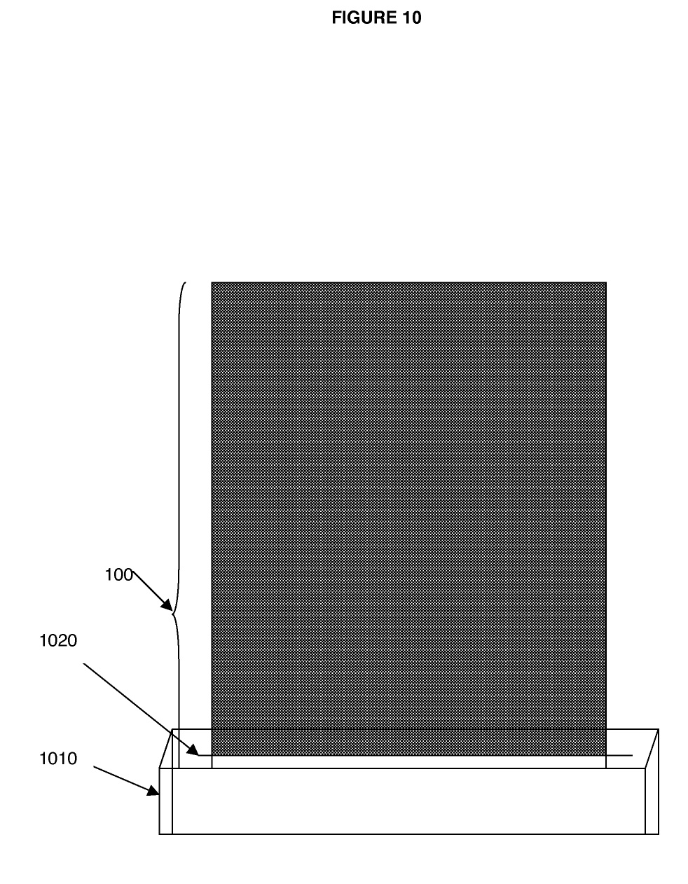

Referring now to FIG. 10, a theme-related greeting card 100 is shown standing upon a base member 1010 that is designed to showcase the greeting card. The greeting card 100 fits into a base holder 1020 such that the base 1010 supports the card 100 for showcasing purposes.

No Figure accompanying this application shows any theme for the themed greeting card 100; it is not practical to show all themes that the themed greeting card 100 can contain within the spirit of the invention. Examples of themes that may be used for the themed greeting card 100 are listed without limitation in the following paragraphs.

One theme embodiment comprises any professionally played sport including but not limited to Aquatics, Archery, Athletics, Badminton, Baseball, Basketball, Biathlon, Bobsleigh, Boxing, Canoe/Kayak, Cricket, Curling, Cycling, Equestrian, Fencing, American Football, Gymnastics, Handball, Hockey, Ice Hockey, Judo, Luge, Modern Pentathlon, Motor Vehicle Racing, Rowing, Sailing, Shooting, Skating, Skiing, Soccer, Softball, Table Tennis, Taekwondo, Tennis, Triathlon, Volleyball, Weightlifting, Wrestling, and other professionally played sports. The holder for such a theme could contain a sports card or tickets to a sporting event, or another small item that is consistent with the theme of the greeting card. These sports should be construed according to the definitions of the professional sports association aligned with that sport in the United States (for example, “Basketball” is a sport defined by the National Basketball Association) as of the date of filing of this application. A professional sports theme may use images of team logos, league logos, athletes, coaches, equipment, playing areas, fans, sports broadcasters, sports museums, or other image designed to elicit the sport.

Another theme comprises any sport played at the high school or college level, including but not limited to Aquatics, Archery, Athletics, Badminton, Baseball, Basketball, Biathlon, Bobsleigh, Boxing, Canoe/Kayak, Cricket, Curling, Cycling, Equestrian, Fencing, American Football, Gymnastics, Handball, Hockey, Ice Hockey, Judo, Luge, Modern Pentathlon, Motor Vehicle Racing, Rowing, Sailing, Shooting, Skating, Skiing, Soccer, Softball, Table Tennis, Taekwondo, Tennis, Triathlon, Volleyball, Weightlifting, Wrestling, and any competitive high school or collegiate sport. These sports should be construed according to the definitions of the National Collegiate Athletic Association in effect on the date of filing of this application. A college/high school sports theme may use images of team logos, school logos, athletes, coaches, playing areas, equipment, fans, sports broadcasters, college sports memorabilia, or other image designed to elicit the nature of the sport.

Another theme comprises any sport played at an amateur level, including but not limited to Aquatics, Archery, Athletics, Badminton, Baseball, Basketball, Biathlon, Bobsleigh, Boxing, Canoe/Kayak, Curling, Cycling, Equestrian, Fencing, American Football, Gymnastics, Handball, Hockey, Ice Hockey, Judo, Luge, Modern Pentathlon, Motor Vehicle Racing, Rowing, Sailing, Shooting, Skating, Skiing, Soccer, Softball, Table Tennis, Taekwondo, Tennis, Triathlon, Volleyball, Weightlifting, Wrestling, and any amateur competitive sport. These sports should be construed according to the definitions of the INTERNATIONAL OLYMPIC COMMITTEE in effect on the date of filing of this application. A college/high school sports theme may use images of team logos, amateur sports logos, the International Olympic Committee logo as it is designed at the time of publication of the greeting card 100, current and past athletes, current and past coaches, playing areas, equipment, fans, sports broadcasters, amateur or Olympic sports memorabilia, or other image designed to elicit the nature of the sport.

Another theme comprises any sport organized for charitable purposes and played by charity recipients through an organized charity such as the SPECIAL OLYMPICS, including but not limited to Alpine Skiing, Aquatics, Athletics, Badminton, Basketball, Bocce, Bowling, Cricket, Cross Country Skiing, Cycling, Equestrian, Figure Skating, Floor Hockey, American Football, Golf, Gymnastics, Powerlifting, Roller Skating, Sailing, Soccer, Softball, Snowboarding, Snowshoeing, Speed Skating, Table Tennis, Team Handball, Tennis, Volleyball, and any sport played by charity recipients through an organized charity. These sports should be construed according to the definitions of the Special Olympics nonprofit organization in effect as of the date of the filing of this application. A charitable sports theme may use images of team logos, charitable organization logos, athletes, coaches, playing areas, equipment, fans, sports broadcasters, charitable sports memorabilia, or other image designed to elicit the charitable nature of the sporting event.

Another theme comprises any competitively played non-sports game, including but not limited to Backgammon, Bridge, Checkers, Chess, Cribbage, Hearts, Mah Jongg, Poker, Pool, real estate and money dealing games such as MONOPOLY®, strategic and tactical games such as RISK®, and other competitively played non-sports game. A competitively played non-sports theme may use images of team logos, game logos, players, coaches, playing areas, equipment, fans, broadcasters, game memorabilia, or other image designed to elicit the nature of the game.

Another theme comprises any popular personality or character such as an actor or actress (this person may be living or deceased), an animated character currently popular or popular in the past, or a superhero character currently popular or popular in the past. A personality/character theme may use images of studio or troupe logos, players, directors, theatres, movie houses, stages, equipment, fans, memorabilia, or other image designed to elicit character or personality.

Another theme comprises any performing art form including but not limited to theatre, movies, music, dance, television shows or television series. A performing arts theme may use images of stages, plays, movies, television personalities, television shows, costumes, makeup, dance shoes, musical instruments, memorabilia, or other image designed to elicit the performing art.

Another theme comprises any visual art form including but not limited to painting, drawing, architecture, photography, or sculpture. A visual arts theme may use images of artists (living or deceased), artwork, architecture, equipment, memorabilia, or other image designed to elicit the visual art.

Another theme comprises a theme selected and developed by the customer, such as family photos, family event announcements (such as birth, first communion, bar/bat mitzvah, graduation, marriage, recognition earned, death), business greetings, business event announcements, or invitations. A consumer-designed theme may use any images or memorabilia chosen by the consumer.

Any other theme may also be used within the subject matter of this invention.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of claims to be examined, and a reasonable equivalency thereof, which I regard as my invention.

I claim:

1. A themed greeting card comprising:
a body composed of a member of the group consisting of paper products, paper, card stock, cardboard, wood, stone, plastic, porcelain, vinyl and metal, said body comprising a front, a back, a top, a bottom, a right side, a left side, said body being configured in a configuration selected from the group consisting of unfolded, folded once and folded twice into a three-paneled configuration;
a holder of sufficient size to hold a theme-related item of trading-card size affixed to said greeting card; and
a display mechanism for said holder such that said themed greeting card forms a frame for said holder.

2. The themed greeting card of claim 1 further comprising said body having at least one fold, an inside and an outside.

3. The themed greeting card of claim 2 further comprising said holder being affixed to said inside.

4. The themed greeting card of claim 2 further comprising said holder being affixed to said outside.

5. The themed greeting card of claim 1 wherein said display mechanism is an optional base member.

6. The themed greeting card of claim 1 further comprising said card being in an unfolded configuration, such as a postcard, with said holder being affixed to one side of said card.

7. The themed greeting card of claim 2 further comprising said body being in a configuration chosen from the group consisting of one or two optional folds, where two optional folds results in a tri-paneled body, said tri-paneled body comprising a center panel and two side panels.

8. The themed greeting card of claim 2 further comprising said inside of said body containing multiple pages.

9. The themed greeting card of claim 1 further comprising said holder being adhesively affixed to said inside of said body

10. The themed greeting card of claim 1 further comprising said holder being adhesively affixed to said outside of said body.

11. The themed greeting card of claim 1 further comprising said holder being slits upon said body, said slits being arranged to hold a trading-card sized object in place when the corners of said object are inserted into said slits.

12. The themed greeting card of claim 1 further comprising a theme being selected from the group consisting of Alpine Skiing, Aquatics, Archery, Athletics, Badminton, Baseball, Basketball, Biathlon, Bobsleigh, Bobsled, Bocce, Bowling, Boxing, Canoe, Kayak, Cricket, Cross Country Skiing, Curling, Cycling, Equestrian, Fencing, Figure Skating, Floor Hockey, American Football, Golf, Gymnastics, Handball, Hockey, Ice Hockey, Judo, Luge, Modern Pentathlon, Motor Vehicle Racing, Ping Pong, Powerlifting, Roller Skating, Rowing, Sailing, Shooting, Skating, Skiing, Snowboarding, Snowshoeing, Speed Skating, Soccer, Softball, Table Tennis, Taekwondo, Team Handball, Tennis, Triathlon, Volleyball, Weightlifting, Wrestling, Backgammon, Bridge, Checkers, Chess, Cribbage, Hearts, Mah Jongg, Poker, Pool, real estate games, money dealing games, strategic games, tactical games, actors, actresses, animated characters, superhero characters, theatre, movies, music, dance, television shows, television series, painting, drawing, architecture, photography, sculpture, and a theme selected and developed by the purchaser.

13. The themed greeting card of claim 12 wherein said theme consists of the logo for a sports team, an image of a player for said team engaging in playing the team sport, contents of said holder being chosen from the group consisting of a trading card for said player and tickets to a team game, and text that reads as if said player were speaking said text.

14. The themed greeting card of claim 12 wherein said theme consists of the title for a show chosen from the group consisting of television series, television show and movies, images of characters from said show, contents of said holder being chosen from the group consisting of a trading card for said character and a show-related event, and text that reads as if said character were speaking said text.

15. A themed greeting card comprising:
a body composed of a member of the group consisting of paper products, paper, card stock, cardboard, wood, stone, plastic, porcelain, vinyl and metal, said body comprising a front, a back, a top, a bottom, a right side, a left side, one or more optional folds, an inside and an outside, and optional multiple pages within said inside, where said theme is chosen from the group consisting of Alpine Skiing, Aquatics, Archery, Athletics, Badminton, Baseball, Basketball, Biathlon, Bobsleigh, Bobsled, Bocce, Bowling, Boxing, Canoe, Kayak, Cricket, Cross Country Skiing, Curling, Cycling, Equestrian, Fencing, Figure Skating, Floor Hockey, American Football, Golf, Gymnastics, Handball, Hockey, Ice Hockey, Judo, Luge, Modern Pentathlon, Motor Vehicle Racing, Ping Pong, Powerlifting, Roller Skating, Rowing, Sailing, Shooting, Skating, Skiing, Snowboarding, Snowshoeing, Speed Skating, Soccer, Softball, Table Tennis, Taekwondo, Team Handball, Tennis, Triathlon, Volleyball, Weightlifting, Wrestling, Backgammon, Bridge, Checkers, Chess, Cribbage, Hearts, Mah Jongg, Poker, Pool, real estate games, money dealing games, strategic games, tactical games, actors, actresses, animated characters, superhero characters, theatre, movies, music, dance, television shows, television series, painting, drawing, architecture, photography, sculpture, and a theme selected and developed by the purchaser;
a holder affixed to said body of sufficient size to hold a theme-related item of trading-card size, said holder being a planar member with a top, a bottom, a left side, a right side, an inside, an outside, and a central portion, said holder being affixed to said body such that said theme-related item can be inserted between said inside of said holder and said body, and said holder being composed of a transparent material chosen from the group consisting of petroleum products and silicon products;
a collectable trading card being inserted into the pocket created by the holder and the themed greeting card, said collectable trading card being a continuation of the theme of said greeting card; and
a display mechanism for said holder such that said card forms a frame for said holder.

16. The themed greeting card of claim 15 further comprising said holder also containing one or more tickets to a theme-related event.

17. The themed greeting card of claim 15 further comprising said body being in a configuration chosen from the group consisting of one or two optional folds, where one optional fold divides said body into two panels, and two optional folds results in a tri-paneled body, said tri-paneled body comprising a center panel and two side panels.

18. The themed greeting card of claim 15 further comprising more than one holder being affixed to said themed greeting card.

19. The themed greeting card of claim 15 wherein said theme consists of the logo for a sports team, an image of a player for said team engaging in playing the team sport, contents of said holder being chosen from the group consisting of a trading card for said player and tickets to a team game, and text that reads as if said player were speaking said text.

20. The themed greeting card of claim 15 wherein said theme consists of the title for a show chosen from the group consisting of television series, television show and movies, images of characters from said show, contents of said holder being chosen from the group consisting of a trading card for said character and a show-related event, and text that reads as if said character were speaking said text.

21. A combination of a themed greeting card and a transparent holder for a theme-related object adhesively affixed to said themed greeting card, said combination comprising:
a body composed of a member of the group consisting of paper products, paper, card stock, cardboard, wood, stone, plastic, porcelain, vinyl and metal, said body comprising a front, a back, a top, a bottom, a right side, a left side, an inside and an outside, one or more optional folds, and optional multiple pages within said inside;
a theme selected from the group consisting of Alpine Skiing, Aquatics, Archery, Athletics, Badminton, Baseball, Basketball, Biathlon, Bobsleigh, Bobsled, Bocce, Bowling, Boxing, Canoe, Kayak, Cricket, Cross Country Skiing, Curling, Cycling, Equestrian, Fencing, Figure Skating, Floor Hockey, American Football, Golf, Gymnastics, Handball, Hockey, Ice Hockey, Judo, Luge, Modern Pentathlon, Motor Vehicle Racing, Ping Pong, Powerlifting, Roller Skating, Rowing, Sailing, Shooting, Skating, Skiing, Snowboarding, Snowshoeing, Speed Skating, Soccer, Softball, Table Tennis, Taekwondo, Team Handball, Tennis, Triathlon, Volleyball, Weightlifting, Wrestling, Backgammon, Bridge, Checkers, Chess, Cribbage, Hearts, Mah Jongg, Poker, Pool, real estate games, money dealing games, strategic games, tactical games, actors, actresses, animated characters, superhero characters, theatre, movies, music, dance, television shows, television series, painting, drawing, architecture, photography, sculpture, and a theme selected and developed by the purchaser;
a holder of sufficient size to hold a theme-related item of trading-card size affixed to said greeting card, said holder being a planar member with a top, a bottom, a left side, a right side, an inside, an outside, and a central portion, said holder being affixed to said body inside or body outside such that said theme-related item can be inserted between said inside of said holder and said body, and said holder being composed of a transparent material selected from the group consisting of petroleum products and silicon products;
a collectable trading card being inserted into the pocket created by the holder and the themed greeting card, said collectable trading card being a continuation of the theme of said greeting card;
a display mechanism for said holder such that said card forms a frame for said holder; and
an embodiment of said theme chosen from the group consisting of (a) said body depicting a logo for a sports team and an image of a player for said team engaging in playing a team sport, contents of said holder being chosen from the group consisting of said trading card being for said player and tickets to a team game, and text that reads as if said player were speaking said text, (b) the title for a performing arts show, images of characters from said show, contents of said holder being chosen from the group consisting of a trading card for said character and a show-related event, and text that reads as if said character were speaking said text, and (c) said body depicting a work of visual art, a trading card related to said work of visual art, and text that reads as if the artist were speaking the text.

22. The combination of claim 21 further comprising said display mechanism being a base member with a slit for holding said themed greeting card for display.
